(19) United States
(12) Patent Application Publication
(10) Pub. No.: US 2004/0250073 A1
(43) Pub. Date: Dec. 9, 2004

(54) Protocol for hybrid authenticated key establishment

(76) Inventors: Johnas I. Cukier, Shrewsbury, MA (US); Qiang Huang, Princeton, NJ (US)

Correspondence Address: Patent Department, Mitsubishi Electric Research Laboratories, Inc., 201 Broadway, Cambridge, MA, 02139, US

(21) Appl. No.: 10/453,706

(22) Filed: Jun. 3, 2003

(51) Int. Cl. H04L 9/00

(52) U.S. Cl. 713/171; 380/277

(57) ABSTRACT

A method and system establishes a link key for encrypting and decrypting messages between a first device having a symmetric secret key and a second device having an asymmetric public key and private key. The first device encrypts the secret key with the public key and a first random number with the secret key. The second device decrypts the secret key with the private key and the first random number with the secret key. Then, the second device encrypts a second random number with the secret key, which is decrypted in the first device with the secret key. The first and second devices can then combine the first and second random numbers to establish the link key for encrypting and decrypting messages between the first and second device.

### FIELD OF THE INVENTION

The present invention relates generally to cryptography and, more particularly, to establishing cryptographic keys.

### BACKGROUND OF THE INVENTION

Cryptographic systems are used in a variety of applications requiring the secure transmission and storage of data. Secure transmission is needed between computers, telephones, facsimile machines, and other devices. Secure storage is required for data stored in memories, disks, smart cards, and portable devices. The principal goal of encryption in all cases is to render communicated and stored data secure from unauthorized eavesdropping and access.

In cryptography, up to now, two mutually exclusive classes of keys and protocols are known: symmetric cryptography and asymmetric or public-key cryptography.

In symmetric cryptography, the same secret key is used for encrypting and decrypting. In this case, both parties must know the secret key. The security of the symmetric protocol can never exceed the security of the single secret key used both for encryption and decryption. Because symmetric keys rely mainly on the secrecy of the key, the secret key does not need to be very large, e.g., 128 bits. Symmetric protocols are relatively fast and easy to implement. The computational complexity and power consumption of symmetric-key schemes are negligible when compared with public-key operations. However, key exchange for symmetric protocols can be complicated, and is always subject to attack by adversaries.

For symmetric protocols, there are three recognized key management problems. First, the secret key can be compromised. The only way to alleviate this problem is to change secret keys frequently. Second, symmetric cryptography requires a large number of secret keys if each unique pair of individuals in a group is to communicate using a different secret key. Third, the secret keys are more valuable than the messages they encrypt. Therefore, the secret keys must be established by a secure protocol, such as a public-key cryptographic protocol.

In asymmetric or public-key cryptography, two different keys are used. A public key, accessible to anyone, is used to encrypt, and a private key, known only to a recipient, is used to decrypt. The security of the public-key protocol relies on the difficulty in analyzing the public key to determine the private key. With public keys, there is no need to maintain a large set of distinct keys, and no initialization process is required to exchange a secret key between two parties. Public keys also have a low broadcast communication complexity. However, public keys need to be quite large, e.g., 1024 bits. This increases computational and communication complexity, and power consumption.

This is an issue for small, low-power devices, such portable PDAs, cellular telephones, and sensors. Public-key cryptographic methods are about 1000 times more complicated than symmetric cryptographic methods. In addition, because public keys are generally available, they could be used by an imposter. This makes authentication a problem.

One possible solution to the authentication problem in public key management, is to use a key distribution center (KDC), which issues secret keys to authorized users. The center provides the basis for identity authentication of transmitted messages. The difficulty is that a central facility must be established as a repository of secret keys, and the facility must be administered by some entity that is trusted. This difficulty is almost impossible to overcome in some applications.

Managing cryptographic keys is the most difficult security problem in both for symmetric and asymmetric key cryptography. Although developing secure keys and protocols is not easy, making sure the keys used with such protocols remain secret is an even more difficult task. The most common point of attack for both symmetric and public-key systems is key management, see Schneier, Applied Cryptography, John Wiley & Sons, Inc., p.140, 1994.

Various exchange protocols are known for establishing keys, such as Shamir's three-pass protocol, U.S. Pat. No. 4,748,668, the COMSET protocol, the Rivest, Shamir and Adleman (RSA) public-key protocol, U.S. Pat. No. 4,405,829, the El Gamal public-key protocol, the Diffie-Hellman public-key protocol, see U.S. Pat. Nos. 4,200,770, 4,218,582, 4,424,414, and Schneier at pp.376-381, all incorporated herein by reference. Using public-key protocols for exchanging symmetric keys remains a problem for small form factor devices.

FIG. 1 shows a prior art symmetric authenticated key exchange to establish a new link key a, see Beller et al., “Privacy and Authentication on a Portable Communications System,” IEEE Journal on Selected Areas in Communications, Vol. 11, No. 6, August 1993, (Beller-Chang-Yacobi), incorporated here by reference. The key exchange is between a device A and a device B using a key distribution center (KDC).

FIG. 2 shows the initialization process, and FIG. 3 shows the authentication process using a challenge-response mechanism. Initially, both the device A and the device B must know a persistent mutual secret key K_{AB} before the protocol can operate. This means the KDC has to maintain a large database of all the secret keys of the devices. The database is difficult to protect and maintain. This requirement is especially troublesome in the case where multiple service providers are involved. Unless the service providers share the database, device A needs separate secret keys for each provider. Without a public-key protocol the device B must calculate and attach N different authentication tags to a message for broadcasting to N devices.

FIG. 4 shows a prior art public-key based authenticated key exchange scheme, see Aziz et al., “A secure communications protocol to prevent unauthorized access—privacy and authentication for wireless local area networks,” IEEE Personal Communications, First Quarter 1994, (Aziz-Diffie) incorporated herein by reference.

In contrast with the symmetric exchange, public key based authenticated key exchange does need to maintain a large set of distinct secret keys, and there is no initialization process to share a persistent secret key between two parties. However, without a shared mutual key, more authentication information is needed. In addition, public keys require more complex modular multiplication, exponentiation, or elliptic curve point multiplication.

Therefore, there is a need for an authenticated key establishment method that does not require a large database for storing keys and does not have a key synchronize problem.

### SUMMARY OF THE INVENTION

A method and system establishes a link key for encrypting and decrypting messages between a first device having an symmetric secret key and a second device having an asymmetric public key and private key.

The first device encrypts the secret key with the public key and first random number with the secret key. The second device decrypts the secret key with the private key and the first random number with the secret key.

Then, the second device encrypts a second random number with the secret key, which is decrypted in the first device with the secret key.

The first and second devices can then combine the first and second random numbers to establish the link key for encrypting and decrypting messages between the first and second device.

In addition, it is possible to authenticate the exchanges of keys and random numbers between the devices with verifiable certificates.

### BRIEF DESCRIPTION OF THE DRAWINGS

FIG. 1 is block diagram of a prior art authenticated symmetric key exchange;

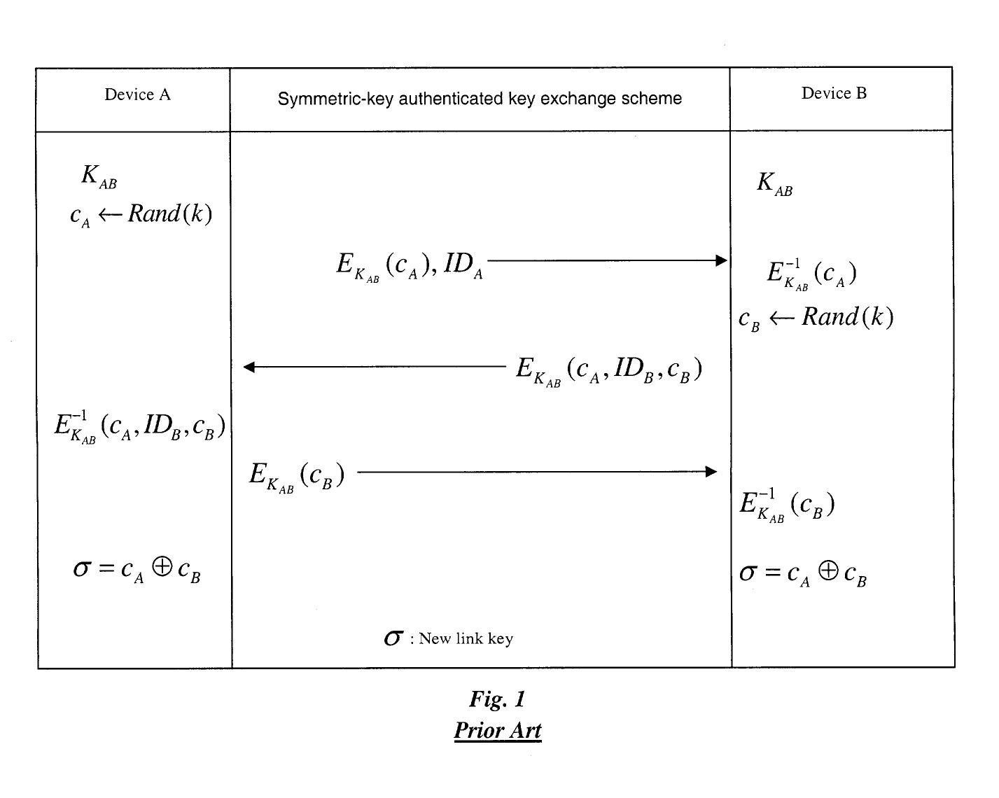

FIG. 2 is a block diagram of initializing the exchange of FIG. 1;

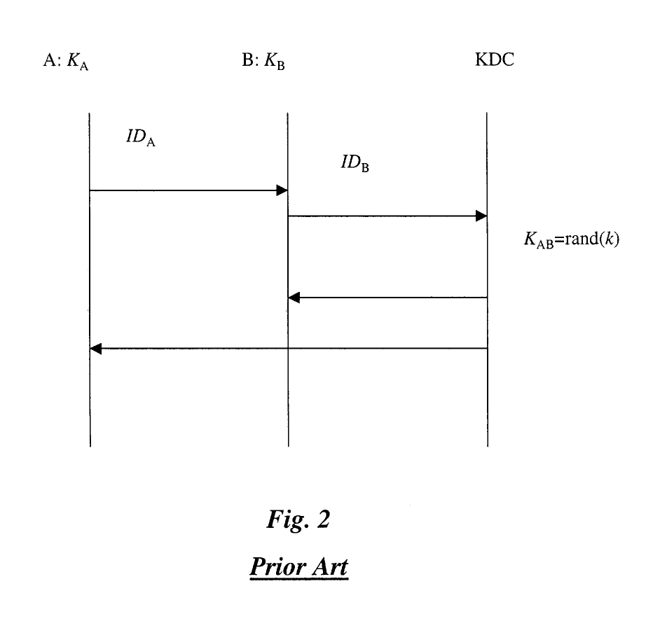

FIG. 3 is a block diagram of challenge and response of the exchange of FIG. 1;

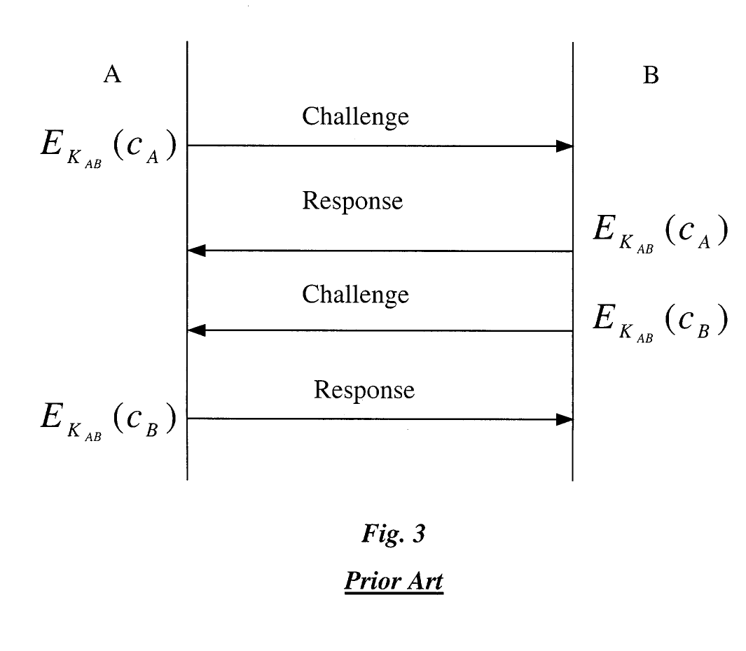

FIG. 4 is block diagram of a prior art authenticated public key exchange;

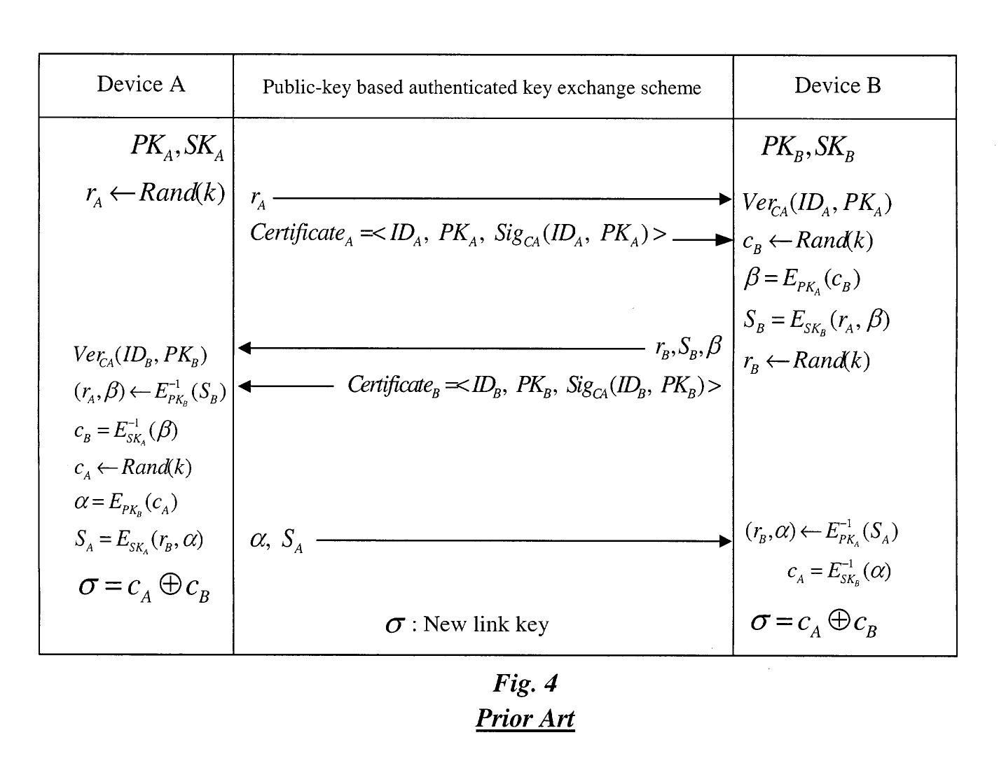

FIG. 5 is a block diagram of hybrid authenticated key exchange according to the invention;

FIG. 6 is a table of verification operations performed with public keys;

FIG. 7 is a table comparing operations of symmetric and asymmetric methods with the hybrid method according to the invention;

FIG. 8 is a graph of computational complexity as a function of ratios of devices;

FIG. 9 shows a network that uses the invention; and

FIG. 10 is a flow diagram of a method for establishing a link key according to the invention.

### DETAILED DESCRIPTION OF THE PREFERRED EMBODIMENT

System Structure

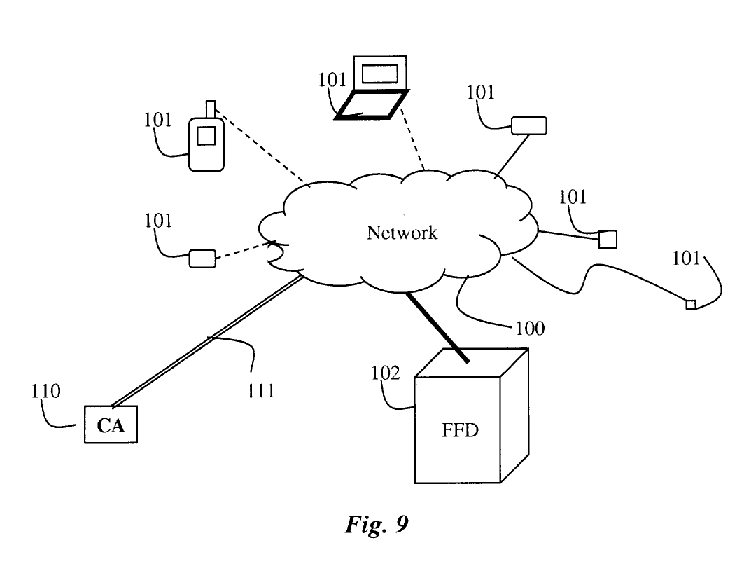

FIG. 9 shows reduced functionality devices (RFDs) 101 coupled to one or more full functionality device (FFD) 102 via a network 100. The invention uses a hybrid authenticated key exchange method to establish crypto-keys for the devices 101 and 102. The network can also connect to a certification authority (CA) 110.

The RFD device 101 has an associated symmetric secret key, and the FFD 102 has associated asymmetric public and private keys.

System Operation

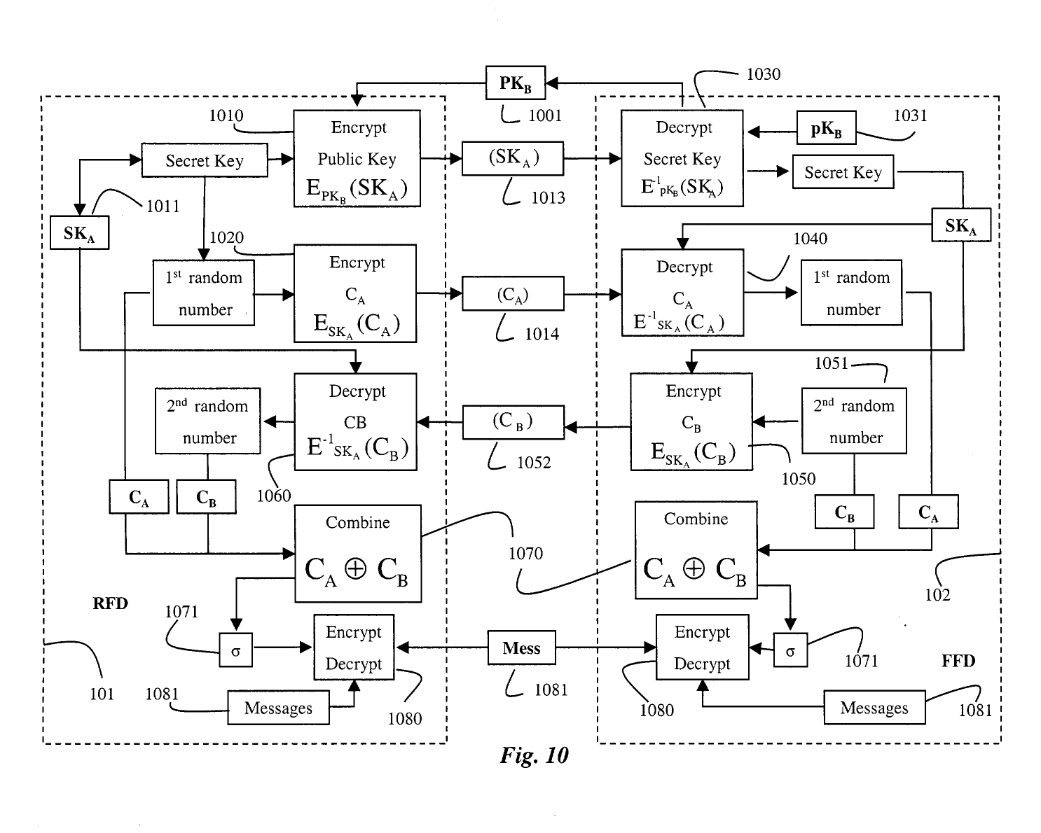

FIG. 10 shows the basic operation of a method for establishing a link key that can be used by the RFD and FFD devices to encrypt and decrypt messages between the devices.

The FFD device 102 broadcasts the public key, PK_{B} 1001.

The RFD device 101 encrypts 1010 its secret key, SK_{A}, 1011 with the public key, and encrypts 1020 a first random number, C_{A}, 1012 with its secret key, and sends both encrypted values 1013-1014 to the FFD device.

The FFD decrypts 1030 the secret key with its private key, pK_{B}, 1031, and decrypts 1040 the first random number with the secret key.

Then, the FFD encrypts 1050 a second random number, C_{B}, 1051 with the secret key and sends the encrypted value 1052 to the RFD.

The RFD decrypts 1060 the second random number.

Now, both the RFD and the FFD can combine (CA ⊕ C_{B}) 1070 the first and second random numbers to establish a link key, λ, 1071 for encrypting and decrypting 1080 messages 1081.

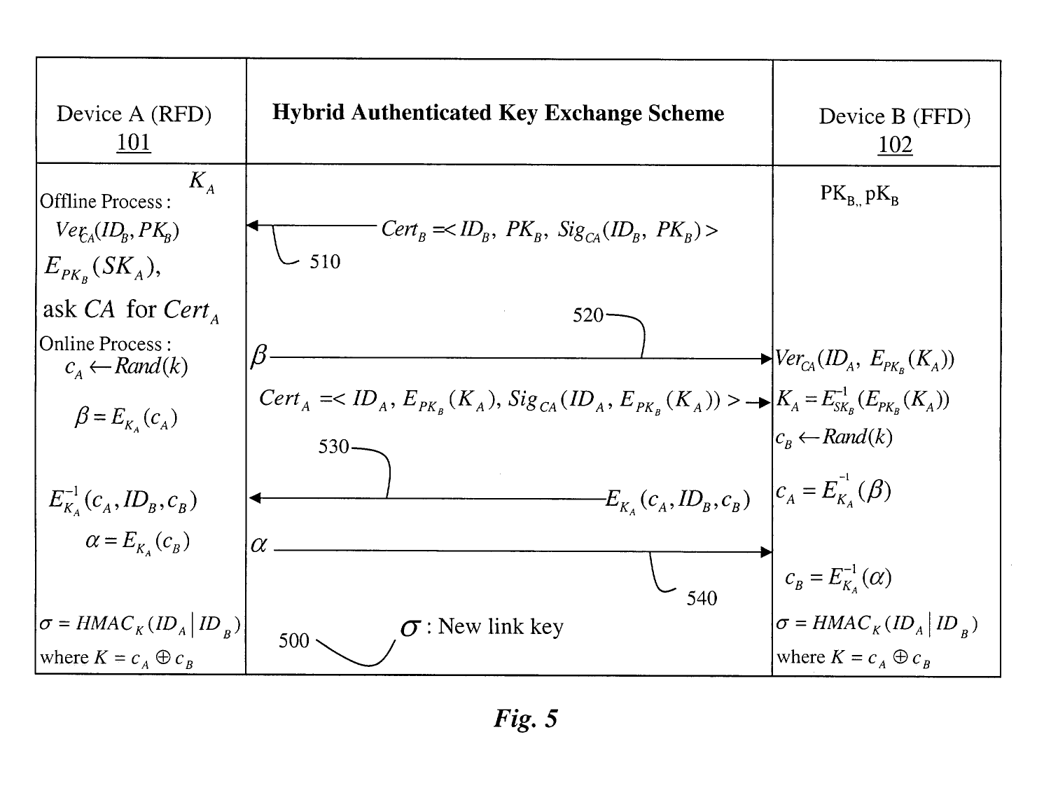

FIG. 5 shows a more robust variation of the hybrid authenticated key establishment method according to the invention. As above, the key exchange is between one of reduced functionality devices (RFD) A 101, for example, a small portable device, and full functionality devices (FFD) B 102, for example, a server computer in a network, a service provider, or a “master” system to establish a link key σ 500. Here, the RFD A has a first identification ID_{A}, and the FFD has a second identification ID_{B}.

The method is particularly useful for applications where the RFD is battery powered and has limited computational power and limited storage, for example a portable computing device, a cellular telephone, or a sensor. There are no power and processing limitations for the full functionality device B. All devices are connected to each other by the network 100, as shown in FIG. 9, for example a personal area network (PAN), or a local area network (LAN). It should be understood that other networks can also be used, and that the network can connect multiple devices to each other, and to other networks of devices.

The hybrid authenticated key exchange method according to the invention eliminates the high cost of public-key decryption and signature generation in the RFD. These operations are replaced with efficient symmetric-key based operations, where possible.

Initially, the protocol assumes that only the RFD has the pre-installed persistent secret key SK_{A}. As an advantage, and unlike prior art symmetric protocols, there is no need for the FFD to know the secret key. The FFD 101 broadcasts or otherwise distributes its public key PK_{B} to all RFDs 101 in the network 100.

In this robust variation, the public key PK_{B} is authenticated with a certificate Cert_{B} acquired from a certification authority (CA). The certificate is checked by running the CA's public verification process.

With the authenticated copy of PK_{B}, the RFD A acquires 510 a certificate Cert_{A} from CA according to:

Cert_{A}=<ID_{A}, E_{PK}_{_{B}}(K_{A}), Sig_{CA}(ID_{A}, E_{PK}_{_{B}}(K_{A}))>,

where the secret key SK_{A} is encrypted (E) with the public key PK_{B}. During this process, The RFD A performs two simple public-key operations, i.e., small modular exponentiation. These operations can be precomputed off-line. Now, RFD A has the certificate Cert_{A} to communicate with the FFD B.

With an operation Rand(k), the protocol starts when the RFD A generates a first random number C_{A} as a challenge to authenticate the FFD B. The random number is encrypted E_{SK}_{_{A}}(c_{A}) according to the secret key SK_{A}. Then, the RFD A sends 520 these, as well as the certificate as a message β, to FFD B. When the FFD B receives the message from the RFD A, the certificate is checked with CA's public verification. If the certificate is valid, then the protocol proceeds.

The RFD B decrypts, i.e., E¹(E_{pK}_{_{B}}(SK_{A})) using its private key pK_{B} to obtains the secret SK_{A}. Now, the secret key SK_{A} is the shared symmetric secret key of the RFD A and the FFD B. The FFD B generates a second random number c_{B}. Using the secret key SK_{A}, an encrypted message E_{SK}_{_{A}} is sent 530 back to the RFD A. The RFD A decrypts the message to determine c_{A}, ID_{B}, and c_{B}. The RFD A knows the message is from the FFD B because apart from the RFD A, only the FFD B knows the secret key SK_{A}. This completes the authentication of the FFD B.

Then, the RFD A encrypts a second random number c_{B} with the secret key SK_{A} and sends 540 it back to the FFD B as message α. When the FFD B receives the message E_{SK}_{_{A}}(c_{B}), it is decrypted to determine whether it contains the second random number c_{B}. If true, the authentication of the RFD A is completed, and both the RFD A and the FFD B can determine the link key σ 500 according to a combination

σ=HMAC_{K}(ID_{A}|ID_{B}),

where HMAC is a one-way, secure, hash message authentication code function, the symbol “|” indicates concatenation, and K=c_{A}⊕c_{B} is used as the key of the HMAC function.

Authentication

The identifications of the RFD A and the FFD B are authenticated by the certificate issued by the CA. The certificates are acquired when devices A and B first subscribe to the service. The certificate can be updated as needed via a secure channel 111 to the CA 110. This is a common assumption in almost all authentication protocols.

To receive a certificate, a device sends its public-key together with its identification through the secure channel 111 to the CA 110. The CA then uses its private key to sign a hashed value of the concatenated message, and then sends the signed certificate and its public key through the secure channel back to the device.

The RFD-FFD authentication is accomplished by the challenge pairs:

(E_{K}_{_{A}}(c_{A}), E_{K}_{_{A}}(c_{A}, ID_{B}, c_{B})) and (E_{K}_{_{A}}(c_{A}, ID_{B}, c_{B})) E_{K}_{_{A}}(c_{B})).

It is infeasible for an adversary to discover the response without knowing the secret K_{A}. Thus, the RFD A is certain that only the FFD B can produce the response. In addition, an adversary cannot obtain any information of the two encrypted random numbers c_{A} and c_{B}. Therefore, the link key contribution of each party is transferred securely to the other party.

Because both the RFD and the FFD contribute the random numbers c_{A} and c_{B} that combine to form the link key 500, no single party has the full control on the selection of the link key, and both the RFD A and the FFD B can ensure the freshness of the link key.

As an advantage of the invention, there is no need to protect and maintain a large database for every device's secret key at the CA. In addition, there is no secret key synchronize problem as with the symmetric prior art method. The RFD A can change its secret key K_{A} at any time and obtain a new certificate without having to notify the FFD B ahead of time. Also, the FFD B does need to contact the CA. When the RFD A sends the new secret key together with the new certificate to the FFD B, the FFD B just replaces the old key with the new secret key.

Computational Complexity

The hybrid scheme according to the invention involves both symmetric-key and public-key cryptography operations in both the RFD and the FFD. The CA 110 is usually securely wired 111, hence the CA does not need to concern itself about the power consumptions. The computational complexity of the symmetric-key operation is negligible compared to that of public-key operation. Because there are far more RFDs 101 than FFDs 102 in the system and RFDs are power limited, the main concern is reducing the public-key operations on RFD side, i.e., the verification (Ver) operation.

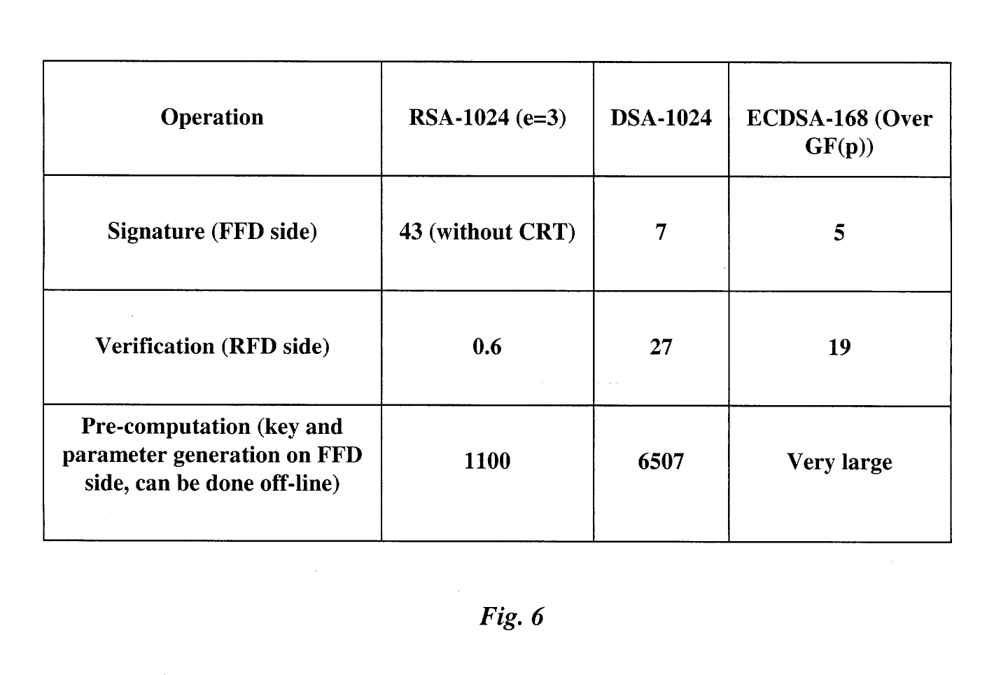

As shown in FIG. 6, the verification timings for RSA-1024, DSA-1024 and ECDSA-168 (Elliptic Curve Digital Signature Algorithm) is 0.6, 27 and 19 milliseconds respectively, on a 200 MHz Pentium Pro. Hence, the preferred embodiment uses RSA-1024 to perform the public-key operations in our hybrid authentication scheme. Although this causes a large exponentiation operation on FFD side, we still achieve a high complexity gain considering the large ratio of the number of RFD to that of FFD. Furthermore, we can use crypto-coprocessors in FFD to facilitate these expensive operation. Many smartcards used nowadays include crypto-coprocessors, which enable fast standard RSA processes, e.g., the Siemens SLE-66 family, and the Philips Semiconductors P8WE5032 family, etc.

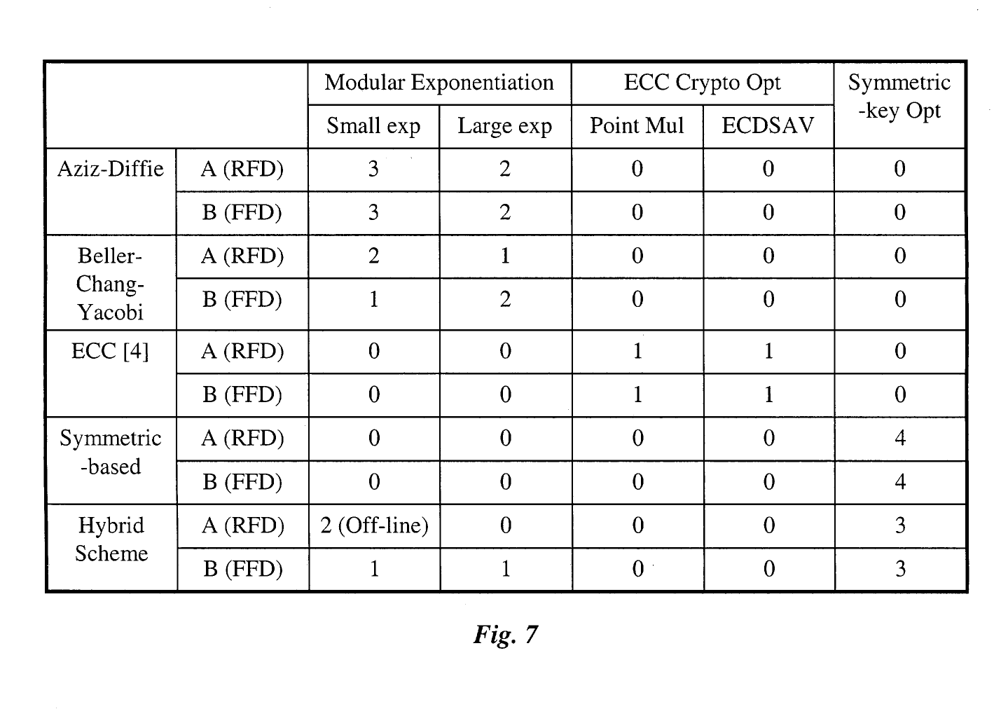

FIG. 7 shows the computation complexity of the hybrid scheme compared with other public-key and symmetric-key based protocols, for ECC see Aydos et al., “An Elliptic Curve Cryptography-based Authentication and Key Agreement Protocol for Wireless Communication,” 2^{nd} International Workshop on Discrete Algorithms and Methods for Mobile Computing and Communications Symposium on Information Theory, October 1998.

In our hybrid scheme, there are three simple symmetric-key operations, which are negligible compared with the cost of public-key computations, and only two small modular exponentiation operations on the RFD side, which can be preformed, one time, off-line, during a preprocessing step. The more complex large modular exponentiation is carried out on the FFD side. The can be speeded up by using the Chinese remainder theorem (CRT).

From FIG. 7, we observe that our hybrid scheme has a much smaller computational complexity than the Aziz-Diffie or Beller-Chang-Yacobi public key based key exchange protocols. Obviously, the symmetric key based protocol has the lowest complexity, but there key management is a problem, as stated above.

In the ECC based public-key key establishment scheme, one signature and one verification operation are required for both the RFD side and the FFD sides. Based on the operational requirements of FIG. 6, the ratio of total computation complexity per link-key-establishment process for the hybrid scheme over the ECC based scheme is

$$\frac{{T}_{hybrid - total}}{{T}_{ECC - total}} = \frac{0.6 * 3 + 43}{2 * ( 5 + 19 )} = 0.933 .$$

The ratio of computation complexity on the RFD side per link-key-establishment process is

$$\frac{{T}_{hybrid - RFD}}{{T}_{ECC - RFD}} = \frac{0.6 * 2}{5 + 19} = 0.05 .$$

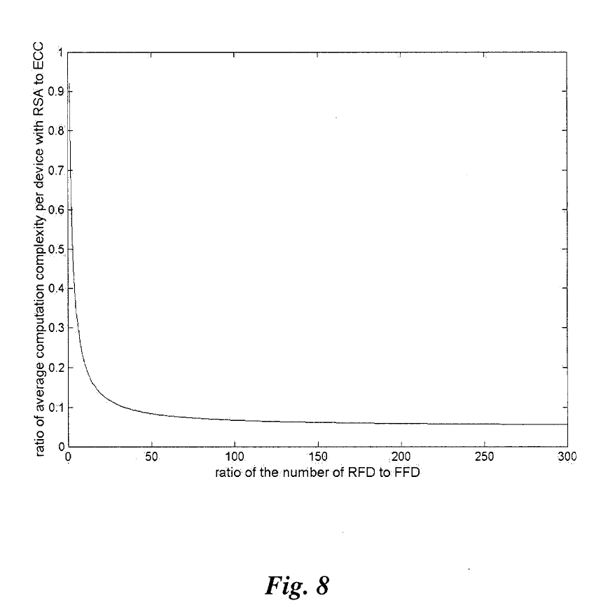

FIG. 8 shows the ratio of average computation complexity per device with RSA compared to that with ECC for ratios of RFDs to FFDs. From FIG. 8, it is clear that the hybrid protocol according to the invention achieves a better computation complexity compared with prior art ECC based protocol.

Communication Complexity

RSA based public-key protocol uses 864 bytes of authentication and key contribution information, while the symmetric-key protocol only needs 96 bytes. In the hybrid scheme according to the invention, the FFD B can cache the secret key K_{A} to save communication complexity for multi-sessions, as long as the RFD uses the same key K_{A} for establishing more than one link key within a short period. Therefore, 240 bytes of information are transmitted, i.e., 12 ms at a data rate of 20 Kb/s, for the first session with a refreshed key K_{A}, and only 96 bytes, i.e., 4.8 ms at a data rate is 20 Kb/s, are needed subsequently when the FFD B caches the secret key K_{A}.

Memory Requirements for Data and Code

In practice, if K_{A}, ID_{A}, ID_{B}, c_{A} and c_{B} are each 128 bits long and 1024-bit RSA is used for public-key cryptography operations, then 416 bytes of persistent memory are required for the FFD to store its parameters, i.e., 2048 bits for its own private key and the RSA modulus, plus 1280 bits for the certificate. On the RFD side, 304 bytes of memory store the 128 bits of the secret key, the 1280 bits of the certificate, and the 1024 bits of the RSA modulus.

Additionally, the RFD needs sufficient random access memory (RAM) to perform the public-key calculations. For 1024-bit RSA with public key e=3, the code requires about 400 bytes of RAM. Code requirements for full RSA and symmetric key encryption algorithm is approximately 5 K bytes.

### EFFECT OF THE INVENTION

When processing power, parameter storage and code space is limited in a device, the hybrid authenticated key protocol according to the invention can eliminate intensive public-key cryptographic operations. Only three symmetric key operations are required, the two relatively simple public-key operations can be performed off-line. The hybrid method has better performance in bandwidth, RFD side computation and storage requirement as compared to the Aziz-Diffie and Beller-Chang-Yacobi public-key based protocols. The invention also solves the key distribution and storage problems, which are typical for symmetric protocols.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for establishing a link key for encrypting and decrypting messages between a first device having an symmetric secret key and a second device having an asymmetric public and private key, comprising:
encrypting the secret key with the public key in the first device;
encrypting a first random number with the secret key in the first device;
decrypting the secret key with the private key in the second device;
decrypting the first random number with the secret key in the second device;
encrypting a second random number with the secret key in the second device;
decrypting the second random number with the secret key in the first device; and
combining the first and second random numbers in the first and second devices to establish the link key for encrypting and decrypting messages between the first and second devices.

2. The method of claim 1 wherein the first device is a reduced functionality device and the second device is a full functionality device.

3. The method of claim 1 further comprising:
authenticating the public key with a first certificate; and
verifying the first certificate in the first device.

4. The method of claim 3 further comprising:
authenticating the encrypted secret key and the first random number with a second certificate; and
verifying the second certificate in the second device.

5. The method of claim 1 further comprising:
authenticating the public key with a first certificate;
verifying the first certificate in the first device;
authenticating the encrypted secret key and the first random number with a second certificate; and
verifying the second certificate in the second device.

6. The method of claim 5 wherein the first certificate includes a first identification of the first device, and the second certificate includes a second identification of the second device.

7. The method of claim 1 wherein the first device has a first identification and the second device has a second identification, and further comprising:
concatenating the first and second identification; and
generating the link key according to a hash function having the combination of the first and second random numbers as a hash key.

8. A system for establishing a link key for encrypting and decrypting messages in a network of devices, comprising:
a first device having a symmetric secret key;
a second device, connected to the first device by the network, having an asymmetric public key and private key, comprising;
means in the first device for encrypting the secret key with the public key and encrypting a first random number with the secret key;
means in the second device for decrypting the secret key with the private key and decrypting the first random number with the secret key, and encrypting a second random number with the secret key;
means in the first device for decrypting the second random number with the secret key; and
means in the first and second devices for combining the first and second random numbers to establish the link key for encrypting and decrypting messages between the first and second device.
